(19) United States
(12) Patent Application Publication
(10) Pub. No.: US 2005/0102702 A1
(43) Pub. Date: May 12, 2005

(54) Cablecard with content manipulation

(76) Inventors: Brant L. Candelore, Escondido, CA (US); Henry Derovanessian, San Diego, CA (US)

Correspondence Address: MILLER PATENT SERVICES, 2500 DOCKERY LANE, RALEIGH, NC, 27606, US

(21) Appl. No.: 10/774,871

(22) Filed: Feb. 9, 2004

Related U.S. Application Data
(60) Provisional application No. 60/524,937, filed on Nov. 25, 2003.
(60) Provisional application No. 60/519,472, filed on Nov. 12, 2003.

(51) Int. Cl. H04N 7/16; H04N 7/173; H04N 7/10; H04N 7/025; H04N 7/167; H04L 9/00

(52) U.S. Cl. 725/100; 725/32; 725/31; 725/118; 380/42; 380/210

(57) ABSTRACT

A CableCARD device for manipulation of a stream of data has an inband data input for receiving a stream of data from a host, the stream of data having a plurality of packets each having a packet identifier (PID) associated therewith, wherein the stream of data further has encrypted packets. A PID remapper selects certain of the packets for remapping of the packet identifiers associated with the selected packets, and remaps the packet identifiers of the selected packets so that the packets are associated with a new packet identifier. A decrypter decrypts the encrypted packets. An encrypter re-encrypts the decrypted packets. An inband data output sends the data stream with remapped packet identifiers back to the host. This abstract is not to be considered limiting, since other embodiments may deviate from the features described in this abstract.

### CROSS REFERENCE TO RELATED DOCUMENTS

This application claims priority benefit of U.S. Provisional patent application No. 60/524,937, filed Nov. 25, 2003, and to U.S. Provisional Patent Application Ser. No. 60/519,472 filed Nov. 12, 2003, which are hereby incorporated by reference. This application is related to patent applications docket number SNY-R4646.01 entitled “Critical Packet Partial Encryption” to Unger et al., Ser. No. 10/038,217; patent applications docket number SNY-R4646.02 entitled “Time Division Partial Encryption” to Candelore et al., Ser. No. 10/038,032; docket number SNY-R4646.03 entitled “Elementary Stream Partial Encryption” to Candelore, Ser. No. 10/037,914; docket number SNY-R4646.04 entitled “Partial Encryption and PID Mapping” to Unger et al., Ser. No. 10/037,499; and docket number SNY-R4646.05 entitled “Decoding and Decrypting of Partially Encrypted Information” to Unger et al., Ser. No. 10/037,498 all of which were filed on Jan. 2, 2002 and are hereby incorporated by reference herein.

### COPYRIGHT NOTICE

A portion of the disclosure of this patent document contains material which is subject to copyright protection. The copyright owner has no objection to the facsimile reproduction of the patent document or the patent disclosure, as it appears in the Patent and Trademark Office patent file or records, but otherwise reserves all copyright rights whatsoever.

### BACKGROUND

The Passage™ initiative, promoted by Sony, provides a mechanism for MSOs (Multiple System Operator) to deploy non-legacy headend equipment, subscriber devices and services on their existing legacy networks. In the USA at present, these networks are usually supplied by either Motorola (former General Instrument) or Scientific Atlanta. These two companies at present constitute better than a 99% share of the US cable system market as turnkey system providers. The systems, by design, employ proprietary technology and interfaces precluding the introduction of non-incumbent equipment into the network. An MSO, once choosing one of these suppliers during conversion from an analog cable system to a digital cable system, faces a virtual monopoly when seeking suppliers for additional equipment as their subscriber base or service offering grows.

Before the Passage™ initiative, the only exit from this situation was to forfeit the considerable capital investment already made with the incumbent provider, due to the intentional incompatibility of equipment between the incumbent and other sources. One primary barrier to interoperability is in the area of conditional access systems, the heart of addressable subscriber management and revenue collection resources in a modern digital cable network.

The Passage™ technologies were developed to allow the independent coexistence of two or more conditional access systems on a single, common plant. Unlike other attempts to address the issue, the two systems operate with a common transport stream without any direct or indirect interaction between the conditional access systems. The basic processes used in these technologies are discussed in detail in the above-referenced pending patent applications.

The above-referenced commonly owned patent applications, and others, describe inventions relating to various aspects of methods generally referred to herein as partial encryption or selective encryption, consistent with certain aspects of Passage™. More particularly, systems are described therein wherein selected portions of a particular selection of digital content are encrypted using two (or more) encryption techniques while other portions of the content are left unencrypted. By properly selecting the portions to be encrypted, the content can effectively be encrypted for use under multiple decryption systems without the necessity of encryption of the entire selection of content. In some embodiments, only a few percent of data overhead is consumed to effectively encrypt the content using multiple encryption systems. Remapping of packet identifiers (PIDS) is used to distinguish between packets utilizing differing types of encryption or in some cases, between clear and encrypted packets or packets used for substitute content. This results in a cable or satellite system being able to utilize Set-top boxes (STB) or other implementations of conditional access (CA) receivers from multiple manufacturers in a single system—thus freeing the cable or satellite company to competitively shop for providers of Set-top boxes.

The term “Passage” as used in the description herein refers to various elements of this technology which will be clear when considered in conjunction with the present disclosure and above-referenced patent applications.

In certain of these disclosures, the clear content is identified using a primary Packet Identifier (PID). A secondary PID (or shadow PID) is also assigned to the program content. Selected portions of the content are encrypted under two (or more) encryption systems and the encrypted content transmitted using both the primary and secondary PIDs (one PID or set of PIDs for each encryption system). The so-called legacy STBs operate in a normal manner decrypting encrypted packets arriving under the primary PID and ignoring secondary PIDs. The newer (non-legacy) STBs operate by associating both the primary and secondary PIDs with a single program. Packets with a primary PID are decoded normally and packets with a secondary PID are first decrypted then decoded. The packets associated with both PIDs are then assembled together to make up a single program stream. The PID values associated with the packets are generally remapped to a single PID value for decoding (shadow PIDs remapped to the primary PID value or vice versa.)

### BRIEF DESCRIPTION OF THE DRAWINGS

Certain exemplary embodiments may be best understood by reference to the following detailed description taken in conjunction with the accompanying drawings in which:

FIG. 1 is a block diagram of a CableCARD interconnected with a host device.

FIG. 2 is a block diagram of a first embodiment of a CableCARD consistent with certain embodiments of the present invention.

FIG. 3 is a block diagram of a second embodiment of a CableCARD consistent with certain embodiments of the present invention.

FIG. 4 is a block diagram of a third embodiment of a CableCARD consistent with certain embodiments of the present invention.

FIG. 5 is a block diagram of a fourth embodiment of a CableCARD consistent with certain embodiments of the present invention.

FIG. 6 is a fifth embodiment of a CableCARD consistent with certain embodiments of the present invention.

FIG. 7 is a flow chart depicting operation of a CableCARD consistent with certain embodiments of the present invention, wherein operations following receipt and prior to sending can be carried out in any suitable order as shown in the other figures.

### ACRONYMS, ABBREVIATIONS AND DEFINITIONS

ASI Asynchronous Serial Interface
CA Conditional Access
CASID Conditional Access System Identifier
CPE Customer Premises Equipment
DHEI Digital Headend Extended Interface
ECM Entitlement Control Message
EPG Electronic Program Guide
GOP Group of Pictures (MPEG)
MPEG Moving Pictures Experts Group
MSO Multiple System Operator
PAT Program Allocation Table
PID Packet Identifier
PMT Program Map Table
PSI Program Specific Information
QAM Quadrature Amplitude Modulation
RAM Random Access Memory
SAN Storage Area Network
VOD Video on Demand

Critical Packet—A packet that, when encrypted, renders a portion of a video image difficult or impossible to view if not properly decrypted, or which renders a portion of audio difficult or impossible to hear if not properly decrypted. The term “critical” should not be interpreted as an absolute term, in that it may be possible to hack an elementary stream to overcome encryption of a “critical packet”, but when subjected to normal decoding, the inability to fully or properly decode such a “critical packet” would inhibit normal viewing or listening of the program content.

Selective Encryption (or Partial Encryption)—encryption of only a portion of an elementary stream in order to render the stream difficult or impossible to use (i.e., view or hear).

Dual Selective Encryption—encryption of portions of a single selection of content under two separate encryption systems.

Passage™—Trademark of Sony Electronics, Inc. for various selective encryption systems and processes.

The terms “a” or “an”, as used herein, are defined as one or more than one. The term “plurality”, as used herein, is defined as two or more than two. The term “another”, as used herein, is defined as at least a second or more. The terms “including” and/or “having”, as used herein; are defined as comprising (i.e., open language). The term “coupled”, as used herein, is defined as connected, although not necessarily directly, and not necessarily mechanically. The term “program”, as used herein, is defined as a sequence of instructions designed for execution on a computer system. A “program”, or “computer program”, may include a subroutine, a function, a procedure, an object method, an object implementation, in an executable application, an applet, a servlet, a source code, an object code, a shared library/dynamic load library and/or other sequence of instructions designed for execution on a computer system.

The terms “scramble” and “encrypt” and variations thereof may be used synonymously herein. Also, the term “television program” and similar terms can be interpreted in the normal conversational sense, as well as a meaning wherein the term means any segment of A/V content that can be displayed on a television set or similar monitor device. The term “video” is often used herein to embrace not only true visual information, but also in the conversational sense (e.g., “video tape recorder”) to embrace not only video signals but associated audio and data. The term “legacy” as used herein refers to existing technology used for existing cable and satellite systems. The exemplary embodiments disclosed herein can be decoded by a television Set-Top Box (STB), but it is contemplated that such technology will soon be incorporated within television receivers of all types whether housed in a separate enclosure alone or in conjunction with recording and/or playback equipment or Conditional Access (CA) decryption module or within a television set itself. The term “CableCARD” as used herein is intended to be synonymous with “POD” or Point of Deployment module, without regard for whether or not the device is used in a cable television system, so long as it carries out an equivalent function. The term “re-encrypt” is used herein to mean that a segment of content is encrypted after having been decrypted, without regard for whether or not the content has changed and the newly encrypted content is actually different from that that was originally decrypted.

### DETAILED DESCRIPTION

There is shown in the drawings and will herein be described in detail specific embodiments, with the understanding that the present disclosure is to be considered as exemplary and is not intended to limit the invention to the specific embodiments shown and described. In the description below, like reference numerals are used to describe the same, similar or corresponding parts in the several views of the drawings.

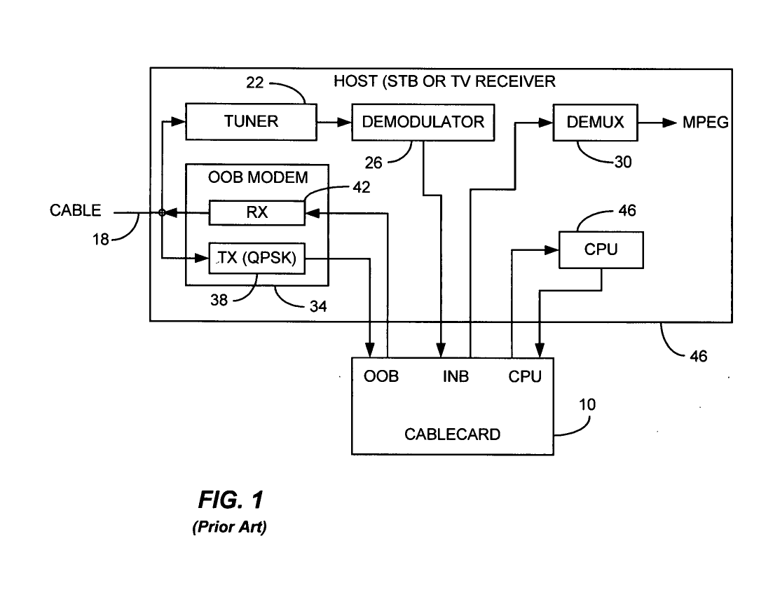

The OpenCable™ specification defines a Point of Deployment Module (POD or CableCARD) for use in conjunction with a host television Set-Top Box or other television receiver as depicted in FIG. 1. As shown, the CableCARD 10 is interfaced with the host device 14 at a CableCARD (or POD) interface. The cable television network cable 18 is used as a transmission medium to send content to and data to and from the host device 14. Content is supplied as a stream of modulated data (e.g., a multiplexed MPEG data stream) to a tuner 22 that selects a particular channel of incoming content. The tuned content is provided to a demodulator 26 which is then provided to the inband (INB) data port of the CableCARD 10. After processing within the CableCARD, the data stream is returned to demultiplexer 30 of host 14, which separates the multiplexed data stream into an MPEG compliant A/V signal.

Out Of Band data (OOB) can also be communicated via cable 18 using OOB modem 34 which, for example, may have a QPSK (Quadrature Phase Shift Keying) transmitter 38 and receiver 42. CableCARD 10 can also send and receive commands and information to and from CPU 46 of host 14.

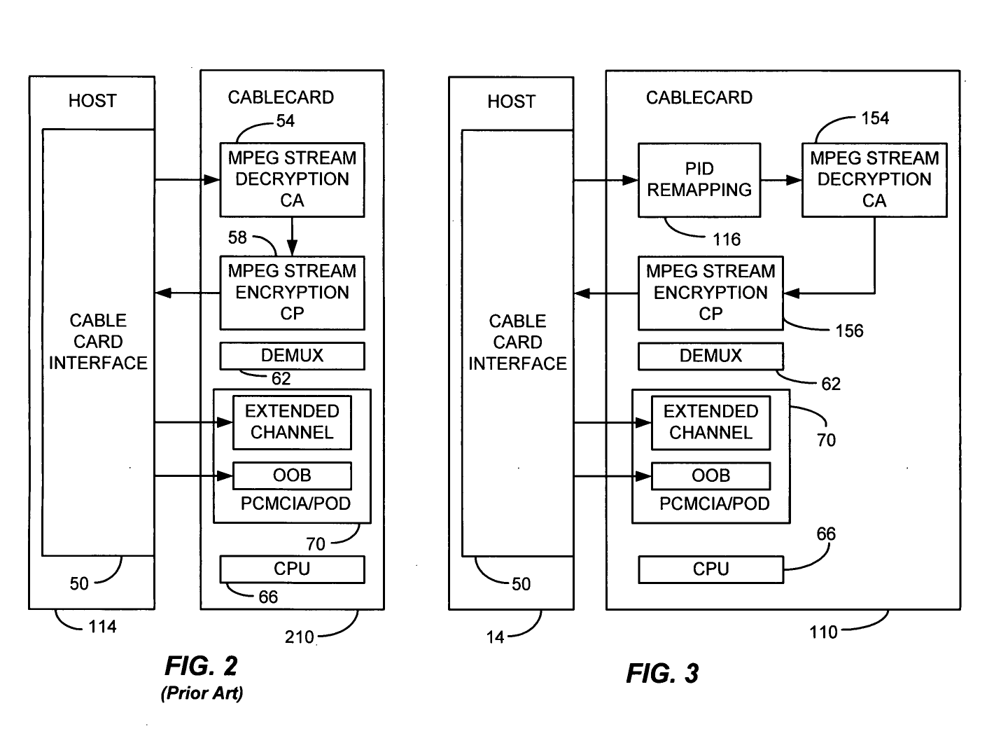

FIG. 2 depicts the conventional CableCARD structure that would normally be used in such a CableCARD. This realization of a CableCARD 10 is coupled to host 14 via interface 50. The CableCARD conventionally receives inband data at an MPEG stream decryption block that decrypts the incoming data stream. When data are returned to the host 14, it is re-encrypted at an MPEG stream encryption device 58. The CableCARD 10 may further incorporate a demultiplexer 62 in order to separate certain content from the stream for processing in the CableCARD, for example, at CPU 66. Out Of Band data are processed at block 70.

In accordance with certain embodiments consistent with the present invention, the CableCARD module is provided with a mechanism to implement various aspects of decryption or decoding of, for example, the Passage™ selective encryption system within the CableCARD. The above-referenced patent applications can be referenced for details of certain embodiments of a selective encryption system using PID remapping functions consistent with those of certain embodiments of the present invention. In particular, decryption and/or PID remapping functions can be carried out within the CableCARD in order to render a generic host STB or other receiver Passage compatible or compatible with other selective encryption or PID remapping functions. Those skilled in the art, upon consideration of the present teaching, will appreciate that the present invention is not limited to systems which are compatible with Sony's Passage™ selective encryption system, since other selective encryption systems, full encryption systems and other systems that utilize PID mapping and remapping can benefit from deriving these functions within a CableCARD to enable a more generic host system to derive its “personality” by virtue of the CableCARD functionality.

One embodiment is depicted in FIG. 3 wherein PID remapping functions as well as MPEG stream descrambling functions are carried out within the CableCARD. In this embodiment, the host device 114 sends a stream of content to a CableCARD 110 via an inband data input (INB). PID remapping (assigning or reassigning a PID value to a packet) is carried out at block 116 prior to a decryption function at 154. The stream is then sent back to the host via an inband data output (INB). If desired, the data returning to the host STB from the CableCARD can be 100% encrypted to inhibit piracy or can be selectively encrypted at encrypter 156. Encrypter 156, thus, re-encrypts the data stream returning to the host 114.

In this embodiment, as well as those that follow, the description is generally in terms of a single MPEG stream that is manipulated. However, multiple streams of content may be received by CableCARD 110 and manipulated individually or manipulated to produce a merged content output stream. For example, content from one stream can have it's PIDs remapped so that it forms a part of another stream in order to effect content substitution (on a one-for-one, one-for-many or many-for-one basis).

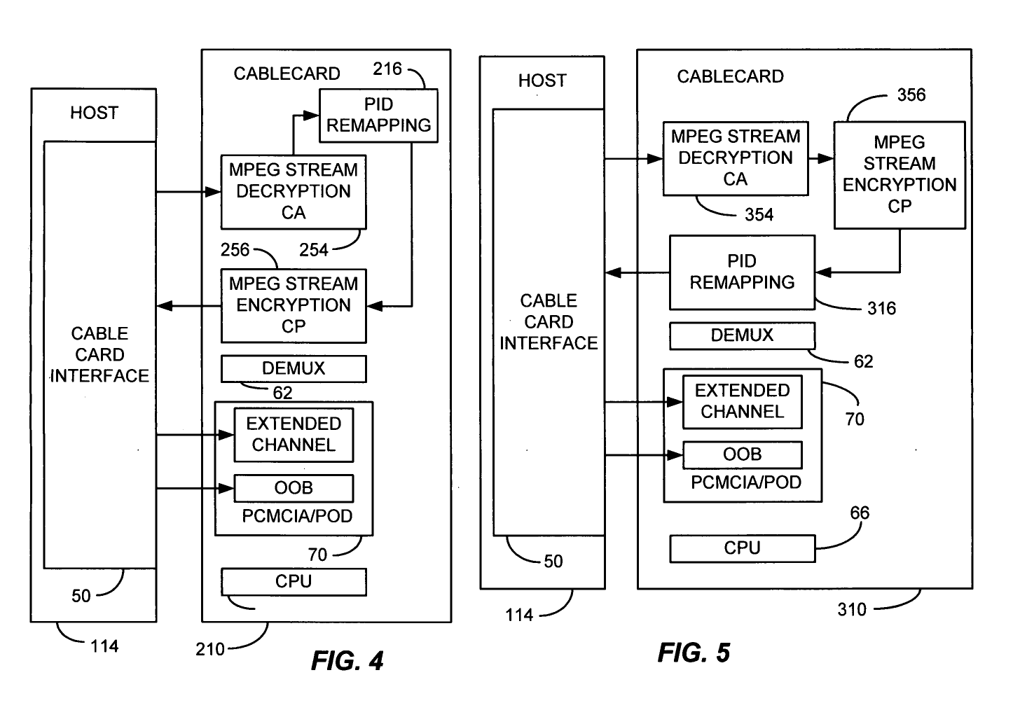

Another embodiment is depicted in FIG. 4 wherein the PID remapping functions as well as MPEG stream descrambling are carried out within the CableCARD 210. In this embodiment, the decryption function at 254 is carried out prior to the PID remapping function at 216. The stream coming back to the host STB from the CableCARD can be 100% encrypted, if desired, to inhibit piracy at 256.

Still another embodiment is depicted in FIG. 5 wherein the PID remapping functions as well as MPEG stream descrambling are carried out within the CableCARD 310. In this embodiment, the decryption function is carried out at decrypter 354 prior to the PID remapping function 316. However, the re-encrypting at 354 of the stream coming back to the host STB 114 from the CableCARD 310 can be carried out between the MPEG stream decryption 354 and the PID remapping 316.

Thus, a method of manipulating a data stream in a CableCARD device, consistent with certain embodiments involves, receiving a stream of data from a host, the stream of data having a plurality of packets each having a packet identifier (PID) associated therewith, and wherein the stream of data further has encrypted packets; selecting certain of the packets for remapping of the packet identifiers associated with the selected packets; remapping the packet identifiers of the selected packets so that the packets are associated with a new packet identifier; decrypting the encrypted packets; re-encrypting the encrypted packets; and sending the data stream with remapped packet identifiers back to the host. In certain embodiments, the PID remapping can be carried out prior to the decrypting, after the decrypting or after the re-encrypting, without limitation.

Another method of manipulating a stream of data in a CableCARD device involves receiving a stream of data from a host, the stream of data comprising a plurality of packets each having a packet identifier (PID) associated therewith; selecting certain of the packets for remapping of the packet identifiers associated with the selected packets; and sending the data stream with remapped packet identifiers back to the host.

Other arrangements, include but are not limited to, arrangements wherein only PID remapping or selective encryption decryption functions are carried out within the CableCARD while remaining functions are carried out in the host STB. Also, while currently the host device is a TV STB, the host could equally well be any television receiver device including the television itself.

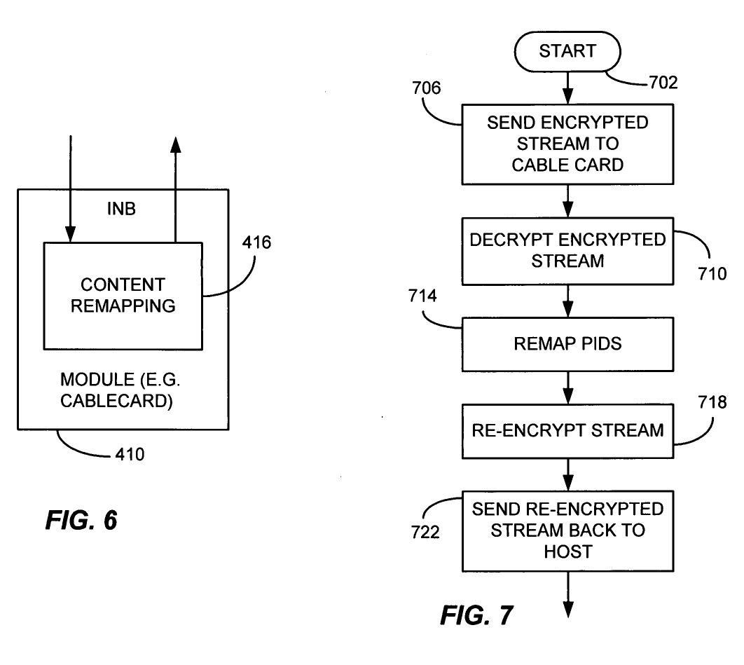

In another example as shown in FIG. 6 consistent with certain embodiments, the CableCARD 410 can provide content remapping function 410 for use in carrying out PID remapping functions to provide content replacement and other functions. The content remapping function as shown in FIG. 6 can be carried out in at least four basic modes consistent with certain embodiments: 1-for-1 packet substitution, Insertion mode, 1-for-multiple packet substitution, and multiple-for-1 substitution. These substitution modes are described in detail in U.S. Provisional Patent Application Ser. No. 60/519,472 filed Nov. 12, 2003 to Candelore which is hereby incorporated by reference. Those skilled in the art will also appreciate that other functions can be carried out using PID remapping after consideration of this disclosure.

As described in the above-referenced provisional patent application, the remapping can be used to substitute packets in the data stream on a packet for packet basis. Or, the remapping can be used to provide for insertion of a packet into the data stream. Or, the remapping can be used to map one packet for multiple packets. Or, the remapping can be used to map multiple packets for one packet.

Thus, in certain embodiments consistent with the present invention, a CableCARD device for manipulation of a stream of data has an inband data input for receiving a stream of data from a host, the stream of data having a plurality of packets each having a packet identifier (PID) associated therewith. A PID remapper selects certain of the packets for remapping of the packet identifiers associated with the selected packets, and remaps the packet identifiers of the selected packets so that the packets are associated with a new packet identifier. An inband data output sends the data stream with remapped packet identifiers back to the host.

In another embodiment, a CableCARD device for manipulation of a stream of data has an inband data input for receiving a stream of data from a host, the stream of data having a plurality of packets each having a packet identifier (PID) associated therewith, wherein the stream of data further has encrypted packets. A PID remapper selects certain of the packets for remapping of the packet identifiers associated with the selected packets, and remaps the packet identifiers of the selected packets so that the packets are associated with a new packet identifier. A decrypter decrypts the encrypted packets. An encrypter re-encrypts the decrypted packets. An inband data output sends the data stream with remapped packet identifiers back to the host.

Referring to FIG. 7, a process as described above is depicted starting at 702. At 706 a stream of encrypted content is sent to the CableCARD. At 710, the content is decrypted and at 714, the content undergoes PID remapping (or alternatively, selection of packets for remapping). In certain embodiments, the PID remapping may involve remapping content from one stream to another. The resultant PID remapped stream is re-encrypted at 718 and sent back to the host device at 722. It will be appreciated by those skilled in the art upon consideration of the present teachings that the order of 710, 714 and 718 can be substantially rearranged so that the PID remapping function 714 appears either before or after 710 or even after 718. Moreover, as previously described, 710 and 718 can be omitted altogether. Additionally, the PID remapping itself may be carried out outside of the CableCARD with only a selection process to select PIDS for remapping carried out within the CableCARD. Other variations will also be apparent to those skilled in the art upon consideration of the present teaching.

Thus, a method of manipulating a stream of data in a CableCARD device, consistent with certain embodiments, involves receiving a stream of data from a host, the data stream comprising a plurality of packets each having a packet identifier (PID) associated therewith; selecting certain of the packets for remapping of the packet identifiers associated with the selected packets; remapping the packet identifiers of the selected packets so that the packets are associated with a new packet identifier; and sending the data stream with remapped packet identifiers back to the host.

In certain embodiments, the stream of data includes encrypted packets. In certain embodiments, the stream of data is selectively encrypted. The process, in certain embodiments, can further involve decrypting the encrypted packets. The process, in certain embodiments, can further involve re-encrypting the decrypted packets. In certain embodiments, the remapping can be carried out on the encrypted packets and/or the unencrypted packets. In certain embodiments, the CableCARD can be an OpenCable™ compliant CableCARD.

Many variations will occur to those skilled in the art upon consideration of the present teaching. For example, and not by way of any limitation, the CableCARD module can obtain descriptors as commands to carry out a number of different tasks, such as:
If it is a CA module and a program is selectively dual encrypted, the module can find its appropriately scrambled content, it can descramble that content, and merge the descrambled content back into the stream. The stream may be copy protected as it goes back to the host device.
If content has multiple ads running at the same time, then the module can pick the appropriate ad, and substitute or merge the ad or other secondary content into the main tuned program and return it back to the host.
If content has various parental blocking content built into it, then it selects the correct adult level of content and substitutes or merges that content into the main tuned program back to the host so that it does not provide unsuitable content to the viewer.

Thus, certain embodiments of the CableCARD module can be used to carry out various functions such as:
Carry two or more content streams wherein content from a first stream is substituted for content from a second stream. Or, content from a first stream is substituted for content from at least one other stream. Thus,
The content can be sent in either IP packets or transport packets.
The content can be, for example, MPEG2, MPEG 4, MPEG 7 or any other suitable protocol or format.
The content can be sent in at least one transport multiplex.
The content can be sent in multiple transport multiplexes.

Thus, rather than having packet PID remapping done by the host, the function can be performed in a removable POD or CableCARD module. In the OpenCable process, CableCARDs will be issued by the cable operators. The CableCARD can be CA specific and process one or more streams. The module can remap a secondary PID packet to a primary PID packet. The remapping can be done to substitute one encrypted packet for another packet, or can be used to carry out various content substitution processes such as banner ads, content blocking or targeted advertising. By use of such a CableCARD, the cable operator can also take advantage of new encryption technology within a system originally designed for use of a particular type of legacy equipment without need to discard all of the legacy equipment at great cost.

Certain embodiments consistent herewith can thus manipulate multiple streams of content. For example, in certain embodiments, a method of manipulating a stream of data in a CableCARD device can involve receiving first and second streams of data from a host, the first and second streams of data comprising a plurality of packets each having a packet identifier (PID) associated therewith; selecting certain of the packets from the second stream of data for remapping of the packet identifiers associated with the selected packets; remapping the packet identifiers of the selected packets so that the packets are associated with a packet identifier that identifies the selected packets as being a part of the first stream; and sending the first stream of data including the selected packets with remapped packet identifiers back to the host.

Certain embodiments can be implemented using a programmed processor. However, other embodiments could be implemented using hardware component equivalents such as special purpose hardware and/or dedicated processors which are equivalents as described and claimed. Similarly, general purpose computers, microprocessor based computers, micro-controllers, optical computers, analog computers, dedicated processors and/or dedicated hard wired logic may be used to construct alternative equivalent embodiments.

The embodiments described herein use MPEG content streams as an example, but this should not be considered limiting, since any content stream could be similarly manipulated.

Those skilled in the art will appreciate that the program steps and associated data used to implement the embodiments described above can be implemented using any suitable computer readable storage medium such as for example Read Only Memory (ROM) devices, Random Access Memory (RAM) devices, optical storage elements, magnetic storage elements, magneto-optical storage elements, flash memory and/or other equivalent storage technologies. Such alternative storage devices should be considered equivalents.

Certain embodiments described herein are implemented using a programmed processor executing programming instructions that are broadly described above in flow chart form that can be stored on any suitable computer readable storage medium or transmitted over any suitable electronic communication medium. However, those skilled in the art will appreciate that the processes described above can be implemented in any number of variations and in many suitable programming languages without departing from the present invention. For example, the order of certain operations carried out can often be varied, additional operations can be added or operations can be deleted without departing from the invention. Error trapping can be added and/or enhanced and variations can be made in user interface and information presentation without departing from the present invention. Such variations are contemplated and considered equivalent.

While specific embodiments have been described, it is evident that many alternatives, modifications, permutations and variations will become apparent to those skilled in the art in light of the foregoing description.

1. A method of manipulating a stream of data in a CableCARD device, comprising:
receiving a stream of data from a host, the stream of data comprising a plurality of packets each having a packet identifier (PID) associated therewith;
selecting certain of the packets for remapping of the packet identifiers associated with the selected packets;
remapping the packet identifiers of the selected packets so that the packets are associated with a new packet identifier; and
sending the data stream with remapped packet identifiers back to the host.

2. The method according to claim 1, wherein the stream of data includes encrypted packets.

3. The method according to claim 2, wherein the stream of data is selectively encrypted.

4. The method according to claim 2, further comprising decrypting the encrypted packets.

5. The method according to claim 4, further comprising re-encrypting the encrypted packets.

6. The method according to claim 4, wherein the remapping is carried out on the encrypted packets.

7. The method according to claim 4, wherein the remapping is carried out on the unencrypted packets.

8. The method according to claim 1, wherein the CableCARD comprises an OpenCable™ compliant CableCARD.

9. The method according to claim 1, wherein the remapping comprises remapping packets to substitute packets in the stream of data on a packet for packet basis.

10. The method according to claim 1, wherein the remapping comprises remapping packets to provide for insertion of a packet into the stream of data.

11. The method according to claim 1, wherein the remapping comprises mapping one packet for multiple packets.

12. The method according to claim 1, wherein the remapping comprises mapping multiple packets for one packet.

13. A method of manipulating a stream of data in a CableCARD device, comprising:
receiving a stream of data from a host, the stream of data comprising a plurality of packets each having a packet identifier (PID) associated therewith, and wherein the stream of data further comprises encrypted packets;
selecting certain of the packets for remapping of the packet identifiers associated with the selected packets;
remapping the packet identifiers of the selected packets so that the packets are associated with a new packet identifier;
decrypting the encrypted packets;
re-encrypting the decrypted packets; and
sending the data stream with remapped packet identifiers back to the host.

14. The method according to claim 13, wherein the stream of data is selectively encrypted.

15. The method according to claim 13, wherein the remapping is carried out prior to the decrypting.

16. The method according to claim 13, wherein the remapping is carried out after the decrypting.

17. The method according to claim 13, wherein the remapping is carried out after the re-encrypting.

18. The method according to claim 13, wherein the CableCARD comprises an OpenCable™ compliant CableCARD.

19. The method according to claim 13, wherein the remapping comprises remapping packets to substitute packets in the stream of data on a packet for packet basis.

20. The method according to claim 13, wherein the remapping comprises remapping packets to provide for insertion of a packet into the stream of data.

21. The method according to claim 13, wherein the remapping comprises mapping one packet for multiple packets.

22. The method according to claim 13, wherein the remapping comprises mapping multiple packets for one packet.

23. A CableCARD device for manipulation of a stream of data, comprising:
means for receiving a stream of data from a host, the stream of data comprising a plurality of packets each having a packet identifier (PID) associated therewith;
a PID remapper that selects certain of the packets for remapping of the packet identifiers associated with the selected packets, and remaps the packet identifiers of the selected packets so that the packets are associated with a new packet identifier;
means for sending the data stream with remapped packet identifiers back to the host.

24. The CableCARD device according to claim 23, wherein the stream of data further comprises encrypted packets.

25. The CableCARD device according to claim 24, further comprising a decrypter for decrypting the encrypted packets.

26. The CableCARD device according to claim 25, further comprising an encrypter for re-encrypting the decrypted packets.

27. The CableCARD device according to claim 24, wherein the stream of data is selectively encrypted.

28. The CableCARD device according to claim 23, wherein the remapping is carried out prior to the decrypting.

29. The CableCARD device according to claim 23, wherein the remapping is carried out prior to the re-encrypting.

30. The CableCARD device according to claim 23, wherein the remapping is carried out after the re-encrypting.

31. The CableCARD device according to claim 23, wherein the CableCARD comprises an OpenCable™ compliant CableCARD.

32. The CableCARD device according to claim 23, wherein the remapping comprises remapping packets to substitute packets in the stream of data on a packet for packet basis.

33. The CableCARD device according to claim 23, wherein the remapping comprises remapping packets to provide for insertion of a packet into the stream of data.

34. The CableCARD device according to claim 23, wherein the remapping comprises mapping one packet for multiple packets.

35. The CableCARD device according to claim 23, wherein the remapping comprises mapping multiple packets for one packet.

36. A CableCARD device for manipulation of a stream of data, comprising:
means for receiving a stream of data from a host, the stream of data comprising a plurality of packets each having a packet identifier (PID) associated therewith, wherein the stream of data further comprises encrypted packets;
a PID remapper that selects certain of the packets for remapping of the packet identifiers associated with the selected packets, and remaps the packet identifiers of the selected packets so that the packets are associated with a new packet identifier;
a decrypter for decrypting the encrypted packets;
an encrypter for re-encrypting the decrypted packets;
means for sending the data stream with remapped packet identifiers back to the host.

37. The CableCARD device according to claim 37, wherein the stream of data is selectively encrypted.

38. The CableCARD device according to claim 37, wherein the remapping is carried out at any point prior to the decrypting, prior to the re-encrypting, or after the re-encrypting.

39. The CableCARD device according to claim 37, wherein the CableCARD comprises an OpenCable™ compliant CableCARD.

40. The CableCARD device according to claim 37, wherein the remapping comprises remapping packets in at least one of the following manners:
remapping packets to substitute packets in the stream of data on a packet for packet basis;
remapping packets to provide for insertion of a packet into the stream of data;
remapping one packet for multiple packets; or
mapping multiple packets for one packet.

41. A method of manipulating a stream of data in a CableCARD device, comprising:
receiving a stream of data from a host, the stream of data comprising a plurality of packets each having a packet identifier (PID) associated therewith;
selecting certain of the packets for remapping of the packet identifiers associated with the selected packets; and
sending the data stream with remapped packet identifiers back to the host.

42. The method according to claim 41, wherein the stream of data includes encrypted packets.

43. The method according to claim 42, wherein the stream of data is selectively encrypted.

44. The method according to claim 42, further comprising decrypting the encrypted packets.

45. The method according to claim 44, further comprising re-encrypting the encrypted packets.

46. The method according to claim 44, further comprising remapping the packet identifiers of the selected packets so that the packets are associated with a new packet identifier, wherein the remapping is carried out on the encrypted packets.

47. The method according to claim 44, further comprising remapping the packet identifiers of the selected packets so that the packets are associated with a new packet identifier, wherein the remapping is carried out on the unencrypted packets.

48. The method according to claim 41, wherein the CableCARD comprises an OpenCable™ compliant CableCARD.

49. The method according to claim 41, further comprising remapping the packet identifiers of the selected packets so that the packets are associated with a new packet identifier.

50. The method according to claim 49, further comprising remapping the packet identifiers of the selected packets so that the packets are associated with a new packet identifier, wherein the remapping comprises remapping packets to substitute packets in the stream of data on a packet for packet basis.

51. The method according to claim 49, wherein the remapping comprises remapping packets to provide for insertion of a packet into the stream of data.

52. The method according to claim 49, wherein the remapping comprises mapping one packet for multiple packets.

53. The method according to claim 49, wherein the remapping comprises mapping multiple packets for one packet.

54. A method of manipulating a stream of data in a CableCARD device, comprising:
receiving first and second streams of data from a host, the first and second streams of data comprising a plurality of packets each having a packet identifier (PID) associated therewith;
selecting certain of the packets from the second stream of data for remapping of the packet identifiers associated with the selected packets;
remapping the packet identifiers of the selected packets so that the packets are associated with a packet identifier that identifies the selected packets as being a part of the first stream; and
sending the first stream of data including the selected packets with remapped packet identifiers back to the host.

55. The method according to claim 54, wherein the remapping comprises remapping packets to provide for insertion of a packet into the first stream of data.

56. The method according to claim 54, wherein the remapping comprises mapping one packet for multiple packets.

57. The method according to claim 54, wherein the remapping comprises mapping multiple packets for one packet.
